(19) United States
(12) Patent Application Publication
(10) Pub. No.: US 2003/0023501 A1
(43) Pub. Date: Jan. 30, 2003

(54) Vendor-managed inventory method and system

(75) Inventor: Eric R. Alling, Upton, MA (US)

Correspondence Address: S. Matthew Cairns, c/o Dike, Bronstein, Roberts & Cushman, IP Group, EDWARDS & ANGELL, LLP, P.O. Box 9169, Boston, MA, 02209, US

(73) Assignee: Shipley Company, L.L.C., Marlborough, MA

(21) Appl. No.: 09/918,108

(22) Filed: Jul. 30, 2001

(51) Int. Cl. G06F 17/60

(52) U.S. Cl. 705/26; 705/28

(57) ABSTRACT

An exemplary embodiment of the invention relates to a method and system for providing vendor-managed inventory services via a vendor-managed inventory tool over a network environment. The method comprises receiving a signal from a sensor device at a buyer system indicating that a minimum level specified for a product used in a manufacturing location is low; receiving a demand note from the buyer system relating to the minimum level; querying a local inventory database at the buyer system for a supply status wherein said querying causes the vendor-managed inventory tool to either: transmit the demand note to a local inventory system for restock of said product, wherein sufficient quantities of said product are locally available; or transmit the demand note to a vendor system, whereby supply levels of are checked in vendor storage and/or vendor warehouse storage. A notice is transmitted to the buyer system where supply levels are sufficient to meet requirements specified in the demand note. If supply levels are insufficient, an order is generated and transmitted to the vendor factory to manufacture the product. Resupply of ordered goods is then effected through standard channels, and invoicing documentation/electronic messages and finances are transacted through standard payment means.

### BACKGROUND

This invention relates generally to vendor managed inventory, and more particularly, the present invention relates to a method and system for providing vendor-managed inventory services to a customer over a network.

Vendor managed inventory (VMI) is a business method which relates to vendor and customer interaction in an effort to minimize the customer's share of the distribution cost associated with distributing a supplier's goods. Vendors that are able to reduce the customer's cost incurred with the purchase and distribution of the vendors' goods provide an added incentive for the customer to stock and sell more goods, if not full lines of the vendors' products.

A key feature in many conventional systems which integrate information relating to business transactions between suppliers and their customers is the use of computers to receive and delegate inventory and invoice information, provided from either the supplier or the customer, and to generate automatic electronic purchase orders therefrom. Through various forms of supplier (manufacturer) and customer (receiver) interaction pursuant to computer-generated purchase orders, the process for the distribution of goods may be streamlined.

For example, U.S. Pat. No. 5,168,445 to Kawashima et al. discloses an automated ordering system for use in a retail shop that is adapted for automatically ordering frequently sold goods. The Kawashima system enables a stock caretaker, such as a shop manager, to understand and utilize factors of changing demand for individual goods in order to assist in the determination of an ideal order amount. The system then electronically determines and uses the ideal order amount as well as other electronically stored information, e.g., the status of the particular stock and factors affecting the stock's storage and use, to electronically determine an order amount and order the goods to replenish inventory.

The Kawashima system electronically generates the ideal order amount by correlating both point of sale data derived from the actual selling results and stock data relating to the actual stocked goods. The correlated data is then massaged according to information input by a user. Such information includes factors indicative of changing sales volume, events in the market area or bargain sale items in the shop, as well as more collateral information such as the weather, geographic area, selling status of other shops, and trade names, to name a few. Calculations are then performed electronically on the data and order slips are automatically generated therefrom.

Although some parts of the Kawashima system are automatic, i.e., the manipulation of data and generation of the order slip, the system is nevertheless conventional in that it relies heavily on the user's contribution and input of data. The Kawashima system is not a fully automated electronic system. That is, once an electronic order is generated for a particular item or manufactured good, the order still must be communicated in some way by and to personnel, as with most conventional systems. No electronic means are provided for tracking and sharing of information relating to any business transaction taking place between a supplier and its customer. Further, the Kawashima system is primarily suited for the retail industry and is not readily adaptable to other buyer/vendor environments, such as manufacturing, which utilize different inventory management processes.

In addition to automatically generating purchase orders, vendor managed inventory systems have attempted to provide users with the ability to streamline the shipping/receiving process. For example, U.S. Pat. No. 5,038,283 to Caveny discloses an electronic based shipping method for facilitating efficient distribution of goods between manufacturer and distributor. The Caveny shipping method requires the labeling of individual items for shipment with identification indicia, labeling a shipping container with container identification indicia and recording in a shipping location computer database the container and identification indicia and including a list of the items shipped in the container. A container packing record is electronically generated according thereto.

The Caveny shipping method electronically transmits the container packing record to a database that is accessible by a shipping destination computer at the shipping destination. There, a customer order list of identification indicia identifying items necessary to fill customer orders, and a list of indicia of containers received at the shipping destination are recorded in a database. The shipping destination computer includes a program to compare the identification indicia of the items recorded in the container packing record of a received container with the identification indicia of the items in the customer order. The received container may thereby be directed to either general inventory or to an area for further shipping, if need be, bypassing the need to handle and check each item of the goods.

While the Caveny shipping method attempts to reduce some of the time and effort associated with the receipt and restocking (handling) of incoming shipments including the prompt filling of outstanding orders, the method still requires significant checking and handling in the form of routing incoming orders at the receiving area of the distributor location.

Commercial software providers have entered the market attempting to automate the vendor-managed inventory processes, but none provide a complete solution that facilitates continuous, inventory monitoring and management on a global scale. A process is therefore desirable which can electronically streamline the communication process associated with the continuous monitoring and management of a customer's product usage necessary to ensure expeditious product/inventory replenishment.

### BRIEF SUMMARY

An exemplary embodiment of the invention relates to a method and system for providing vendor-managed inventory services via a vendor-managed inventory tool over a network environment. The method comprises receiving a signal from a sensor device at a buyer system indicating that a minimum level specified for a product used in a manufacturing location has been reached; receiving a demand note from the buyer system relating to the minimum level; querying a local inventory database at the buyer system for a supply status wherein said querying causes the vendor-managed inventory tool to either: transmit the demand note to a local inventory system for restock of said product, wherein sufficient quantities of said product are locally available; or transmit the demand note to a vendor system, whereby supply levels of are checked in vendor storage and/or vendor warehouse storage. A notice is transmitted to the buyer system where supply levels are sufficient to meet requirements specified in the demand note. If supply levels are insufficient, an order is generated and transmitted to the vendor factory to manufacture the product. Resupply of ordered goods is then effected through standard channels, and invoicing documentation/electronic messages and finances are transacted through standard payment means.

### BRIEF DESCRIPTION OF THE DRAWINGS

Referring now to the drawings wherein like elements are numbered alike in the several FIGURES:

FIG. 1 is a portion of a block diagram with which the vendor-managed inventory tool is implemented in an exemplary embodiment; and

FIG. 2 is a flowchart illustrating the process flow involved in the vendor-managed inventory system in an exemplary embodiment.

### DETAILED DESCRIPTION OF THE PREFERRED EMBODIMENT

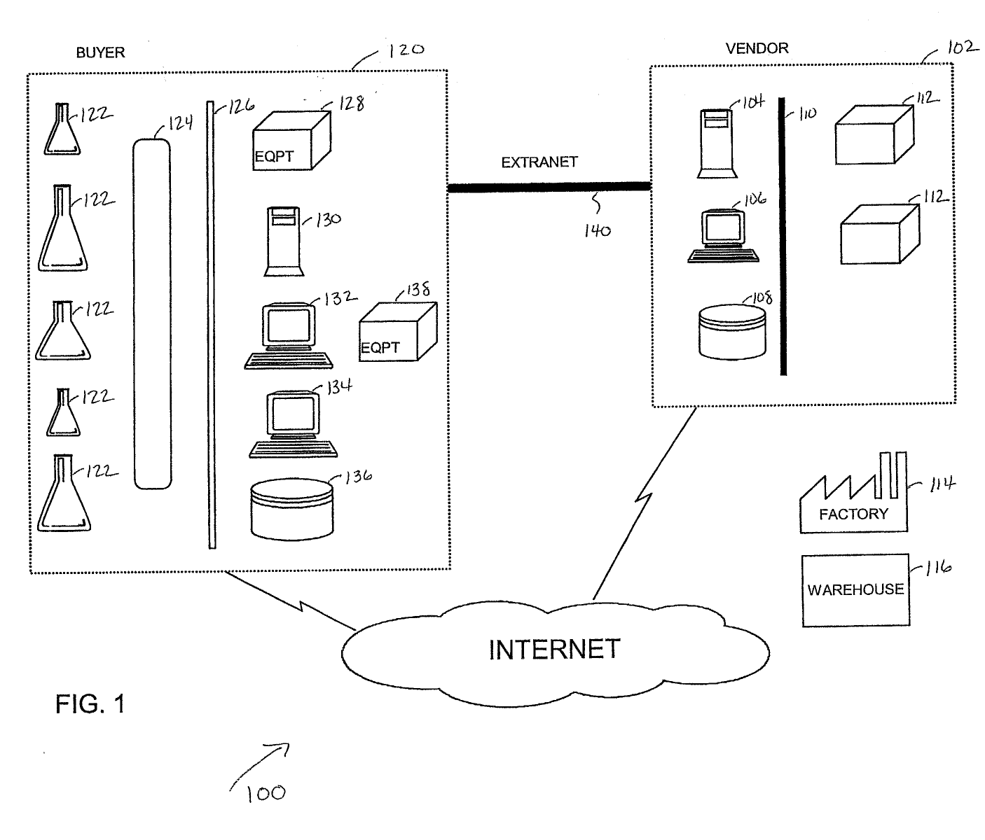

In an exemplary embodiment, the vendor-managed inventory tool is implemented via a computer-based network environment such as that shown in system 100 of FIG. 1. System 100 illustrates a vendor system 102 including a server 104, a workstation 106, and a data storage device 108 each in communication with each other via a communications link 110. Storage locations 112 may also be connected to communications link 110 and represent localized, on-site inventory repositories within vendor system 102. Storage locations 112 house products and materials for sale to manufacturing customers such as buyer system 120. Storage locations 112 may be connected to link 110 via telephone, facsimile, or other electronic means known in the art. The vendor-managed inventory tool may be stored on and executed by server 104, workstation 106, or a combination both. In an alternative embodiment, the vendor-managed inventory tool may be implemented via buyer system 120 in a similar manner as described herein with respect to vendor system 102.

Buyer system 120 is typically a manufacturing plant or facility which purchases production materials from vendor system 102. Buyer system 120 includes receptacles 122 connected or linked to a sensor device 124 which monitors and measures the contents of materials in receptacles 122. Although only one sensor device 124 is shown, buyer system 120 may alternatively be configured to include multiple sensor devices as required in accordance with system's 120 needs. Equipment devices 128 and 138 are typically manufacturing or production machinery which consume or expend the materials contained within one or more of receptacles 122. Equipment device 128 is directly connected to network link 126 and is capable of transmitting production/manufacturing data through network 126 to other devices within system 120 such as server 130, workstations 132 and 134 and data storage device 136. Workstation 132 is linked to a second equipment device 138 from which it receives electronic data related to production activities and transmits this data to server 130. Server 130 receives data from equipment device 128, workstations 132 and 134, and data storage device 136 via network link 126 as well as from sensor 124. Sensor device 124 measures quantity values from receptacles 122 and, based upon business rules adopted by buyer system 120, triggers a signal to a corresponding equipment device such as equipment device 128, and ultimately to network link 126 when quantities fall below a specified level. Any suitable sensor device may be utilized by buyer system 120 to achieve the advantages of the invention. Sensor devices which measure quantities of liquids or goods consumed in manufacturing are well known to those skilled in the art. Network 126 may comprise any communications architecture and infrastructure suitable for transmitting production data between devices and equipment implemented by buyer system 120. For purposes of illustration, however, network 126 is an Intranet.

Vendor system 102 and buyer system 120 may communicate with each other via any appropriate high-speed communications network technology known in the art, such as a private network, Extranet 140, or the Internet, and may include wireless technology and devices. Factory 114 represents an external source of vendor system's 102 manufacturing materials which are produced on behalf of vendor system 102 and its customers. Warehouse 116 is any external storage facility owned by, operated by, or under an agreement with vendor system 102 and which houses goods and materials sold by vendor system 102. When materials stored in vendor system's 102 internal storage locations 112 are depleted or are nearing depletion, it contacts factory 114 and/or warehouse 116 to either increase production or shipment of goods. Factory 114 and warehouse 116 may be in communication with vendor system 102 by any means of communications technology known in the art and desirable by vendor system 102.

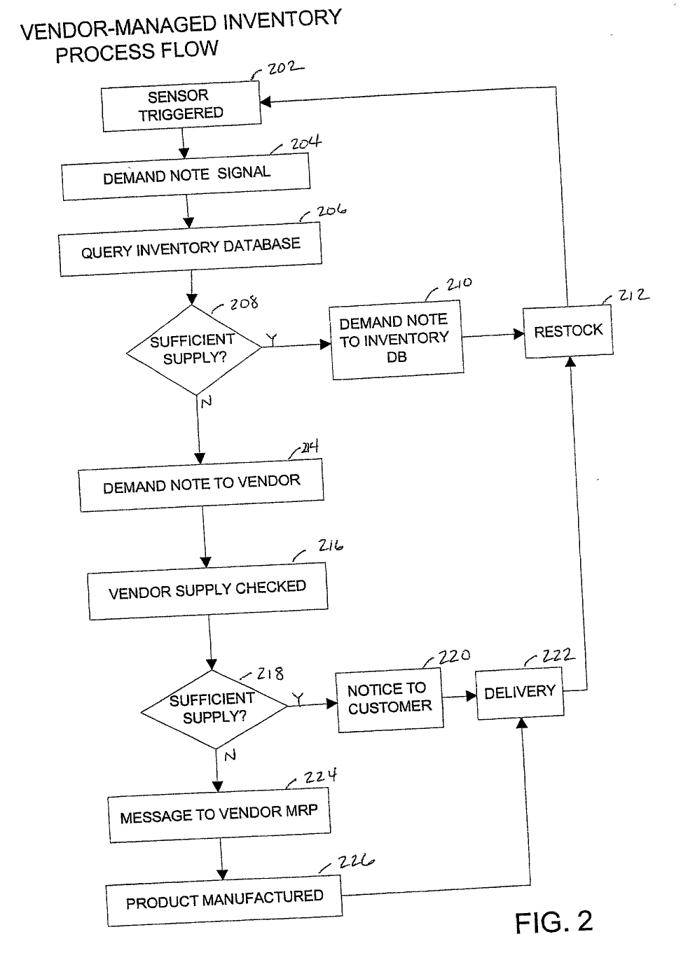

FIG. 2 illustrates the process for managing and replenishing a customer's inventory utilizing the vendor-managed inventory tool. A sensor device 124 is triggered where a product or consumable in one of receptacles 122 has reached a minimum level at step 202. Minimum and maximum levels may be set by buyer system 120 in accordance with adopted business rules. Production equipment device 138, which is monitoring and utilizing this resource, receives a signal from sensor device 124 and causes workstation 132 to issue a demand note via network 126 to server 130 at step 204. Server 130 then queries the customer inventory database in data storage device 136 for information at step 206. The customer inventory database checks to see if sufficient quantities exist in local storage (not shown) at step 208. If so, a demand note is generated by server 130 and transmitted to customer inventory at step 210. Alternatively, if the desired consumable is stored in a warehouse under a consignment arrangement with vendor system 102, then an electronic purchase order may be issued by buyer system 120 in addition to, or in lieu of, the demand note provided above. Receptacle 122 is restocked at step 212 and awaits the next sensor trigger at 202.

If there is insufficient quantities of the product in local storage at buyer system 120, flow proceeds to step 214 whereby a demand note and/or electronic purchase order is issued by server 130 to vendor system 102 via network 140 or the Internet. Vendor system 102 checks its supply in local storage 112 and, if necessary, at local warehouse 116 at step 216. If sufficient quantities exist to meet the demands of the customer demand note (218), then a response notice is transmitted to buyer system 120 at 220, followed by physical delivery of the goods and related billing activities at step 222. The customer then restocks receptacle 122 at step 212 which then awaits the next sensor trigger at step 202.

If sufficient quantities do not exist at vendor system's 102 site 112 or local warehouse 116, a message is generated and transferred to factory 114 at step 224, and the product specified in the demand note or electronic purchase order is manufactured at step 226, shipped to buyer system 120 at step 222, followed by customer restocking and related billing activities at 212.

The method and system of the vendor-managed inventory tool described above offers a unique ability to monitor and manage global customer product usage while integrating this data and distribution lag-time into vendor systems in order to optimize the commercial cycle of supply-consumption and re-supply.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A method for providing vendor-managed inventory services via a vendor-managed inventory tool over a network environment, comprising:
receiving a signal from a sensor device at a buyer system indicating that a minimum level specified for a product used in a manufacturing location has been reached, said level measured by a quantity of said product;
receiving a demand note from said buyer system requesting restocking of said product;
querying a local inventory database for a supply availability status wherein said querying causes said vendor-managed inventory tool to:
transmit said demand note to a local inventory system for said restocking of said product,
wherein said querying indicates that sufficient quantities of said product are locally available at said buyer system; and
transmit a purchase order to a vendor system;
check supply levels of said product in vendor system storage;
check supply levels of said product in vendor warehouse storage under consignment;
transmit a notice to said buyer system where said supply levels of said product in said vendor system storage or said vendor warehouse storage are sufficient to meet requirements specified in said purchase order; and
transmit said purchase order to a factory for manufacture of said product, where said supply levels are insufficient to meet said requirements specified in said purchase order;
wherein said querying indicates that insufficient quantities of said product are locally available at said buyer system.

2. The method of claim 1, wherein said minimum level specified for said product is determined by said buyer system and implemented via said vendor-managed inventory tool.

3. The method of claim 1, further comprising specifying a maximum level acceptable for said product via said vendor-managed inventory tool.

4. A storage medium encoded with machine-readable computer program code for providing vendor-managed inventory services via a vendor-managed inventory tool over a network environment, the storage medium including instructions for causing a computer to implement a method comprising:
receiving a signal from a sensor device at a buyer system indicating that a minimum level specified for a product used in a manufacturing location has been reached, said level measured by a quantity of said product;
receiving a demand note from said buyer system requesting restocking of said product;
querying a local inventory database for a supply availability status wherein said querying causes said vendor-managed inventory tool to:
transmit said demand note to a local inventory system for said restocking of said product,
wherein said querying indicates that sufficient quantities of said product are locally available at said buyer system; and
transmit a purchase order to a vendor system;
check supply levels of said product in vendor system storage;
check supply levels of said product in vendor warehouse storage under consignment;
transmit a notice to said buyer system where said supply levels of said product in said vendor system storage or said vendor warehouse storage are sufficient to meet requirements specified in said purchase order; and
transmit said purchase order to a factory for manufacture of said product, where said supply levels are insufficient to meet said requirements specified in said purchase order;
wherein said querying indicates that insufficient quantities of said product are locally available at said buyer system.

5. The storage medium of claim 4, wherein said minimum level specified for said product is determined by said buyer system and implemented via said vendor-managed inventory tool.

6. The storage medium of claim 4, further comprising instructions for causing said computer to implement:
specifying a maximum level acceptable for said product via said vendor-managed inventory tool.

7. A system for providing vendor-managed inventory services via a vendor-managed inventory tool over a network environment, comprising:
a vendor system including:
a server;
a workstation in communication with said server;
a data storage device in communication with said server; and
a storage location in communication with said server;
wherein said communication is facilitated by an electronic communications link; and
a network link to:
a buyer system;
a manufacturing system; and
a storage warehouse.

8. The system of claim 7, wherein said manufacturing system produces products for use by said buyer system.

9. The system of claim 7, wherein said vendor system manages inventory levels for products consumed by said buyer system via said vendor-managed inventory tool.

10. The system of claim 9, wherein said inventory levels of said products are monitored by a sensor device located at said buyer system.

11. The system of claim 10, wherein said sensor device transmits a signal to said vendor system via said vendor-managed inventory tool relating to a specified inventory level.

12. The system of claim 7, wherein said vendor-managed inventory tool facilitates billing activities between said vendor system, said buyer system, said manufacturing system and said warehouse, said activities including:
purchase order generation and transmission;
demand note generation and transmission; and
invoice generation and transmission.

13. The system of claim 12, wherein information relating to said billing activities is stored in said data storage device.

14. The system of claim 7, wherein said vendor-managed inventory tool causes said vendor system to provide delivery of said goods pursuant to said demand note.

15. The system of claim 7, wherein said vendor-managed inventory tool causes said vendor system to provide delivery of goods pursuant to said purchase order.
